(19) United States
(12) Patent Application Publication
(10) Pub. No.: US 2015/0043918 A1
(43) Pub. Date: Feb. 12, 2015

(54) Double Capacity Pluggable Optics

(71) Applicant: ARRIS Enterprises, Inc., Suwanee, GA (US)

(72) Inventors: Zoran Maricevic, West Hartford, CT (US); Venkatesh G. Mutalik, Middletown, CT (US); Marcel F. Schemmann, Maria Hoop (NL)

(21) Appl. No.: 14/456,624

(22) Filed: Aug. 11, 2014

Related U.S. Application Data
(60) Provisional application No. 61/864,030, filed on Aug. 9, 2013.

(51) Int. Cl. H04B 10/25

(52) U.S. Cl. CPC H04B 10/2504
USPC 398/79; 398/200; 398/188

(57) ABSTRACT

The methods, systems, and apparatuses described in this disclosure enable the use of pluggable optics such that two outgoing connections or two incoming connections can support the use of dual transmitter optics and/or dual receiver optics. The forward and/or reverse capacity of an optical network can be doubled using two transmitters and/or receivers operating in parallel. In embodiments, forward and/or reverse capacity of an optical network can be doubled using a double capacity transmitter or receiver that is operable to combine two or more electrical signals into a single optical signal. A pluggable can support two transmitting or two receiving optical links, and can also support a double capacity transmitting or receiving optical link.

### CROSS REFERENCE TO RELATED APPLICATION

This application is a non-provisional application claiming the benefit of U.S. Provisional Application Ser. No. 61/864,030, entitled “Double Capacity Pluggable Optics,” which was filed on Aug. 9, 2013, and is incorporated herein by reference in its entirety.

### TECHNICAL FIELD

This disclosure relates to optical fiber interfaces.

### BACKGROUND

Multiple services operators (MSO) use network infrastructure for carrying data traffic, television content signals, voice, video-on-demand (VoD), among other types of signals to a subscriber. Generally, forward (e.g., downstream) and reverse (e.g., upstream) traffic in a network is not balanced. For example, there is typically a greater amount of forward traffic than reverse traffic on a network, thus creating a higher priority for allocation of network resources to support forward traffic. Typically, digital optical fiber networks are designed to provide equivalent capacity for both forward and reverse traffic. For example, a pluggable optic (e.g., interface for an optical fiber network) typically includes both a transmitter and a receiver, wherein each is capable of running at a predetermined bitrate to support bidirectional links. Likewise, electrical interfaces to the pluggable optics typically support one outgoing connection (e.g., to drive an associated transmitter) and one incoming connection (e.g., to take in data from an associated receiver). In order to increase forward capacity in a network, an increased number of pluggable optics would need to be installed. However, installation of more pluggable optics comes at the cost of providing unneeded reverse capacity and taking up space in routers and switches. Therefore, a need exists for an optical fiber interface operable to provide for increased forward data capacity on an optical fiber network.

### BRIEF DESCRIPTION OF THE DRAWINGS

FIG. 1 is a block diagram illustrating an example network environment operable to facilitate the transmission of data traffic at two wavelengths.

FIG. 2 is a block diagram illustrating example network components operable to facilitate the transmission of data traffic at two wavelengths.

FIG. 3 is a block diagram illustrating an example network environment operable to facilitate the transmission of data traffic along a single optical fiber.

FIG. 4 is a block diagram illustrating example network components operable to facilitate the transmission of data traffic along a single optical fiber.

FIG. 5 is a block diagram illustrating example network components operable to facilitate the transmission of data traffic along a single optical fiber.

FIG. 6 is a flowchart illustrating an example process operable to facilitate transmission of data traffic along an optical fiber.

FIG. 7 is a flowchart illustrating an example process operable to facilitate transmission of data traffic along an optical fiber.

FIG. 8 is a flowchart illustrating an example process operable to facilitate transmission of data traffic at two different wavelengths.

Like reference numbers and designations in the various drawings indicate like elements.

### DETAILED DESCRIPTION

It is desirable to improve upon delivery of forward data along optical fiber networks. Generally, an optical pluggable includes both a transmitter and a receiver, such that the capacity of the pluggable is evenly split between transmitting and receiving. Methods, systems and apparatuses are described herein for utilizing the full capacity of an optical pluggable for transmission of forward data. In embodiments, optical pluggables can provide an increase in capacity in one direction only (usually forward) within the same footprint as that of conventional bidirectional optical pluggables. The methods, systems, and apparatuses described herein enable the use of pluggable optics such that two outgoing connections or two incoming connections can support the use of dual transmitter optics and dual receiver optics. The forward and/or reverse capacity of an optical network can be doubled using two transmitters and/or receivers operating in parallel.

In embodiments, forward and/or reverse capacity of an optical network can be doubled using a double capacity transmitter or receiver that is operable to combine two or more input signals into a single optical signal. A pluggable can support two transmitting or two receiving optical links, and can also support a double capacity transmitting or receiving optical link. Thus, the forward or reverse capacity of an optical network can be doubled without increasing the amount of equipment (e.g., ports, cards, etc.) or the size of existing equipment. Pluggables may include small form-factor pluggables (SFP), enhanced small form-factor pluggables (SFP+), 10 gigabit small form-factor pluggables (XFP), and others.

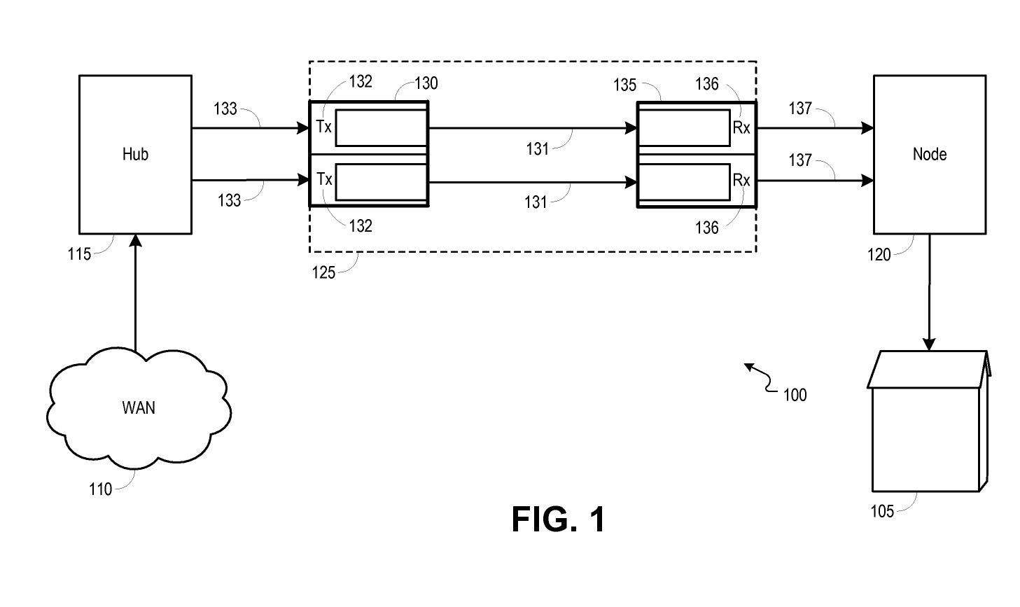

FIG. 1 is a block diagram illustrating an example network environment 100 operable to facilitate the transmission of forward traffic along two wavelengths. In embodiments, video, data, and/or voice services can be delivered to a subscriber premise 105 from a wide area network (WAN) 110. In embodiments, communications between the WAN 110 and the subscriber premise 105 can be routed through one or more of various network components including, but not limited to, a headend (not shown), hub 115, node 120, as well as others.

In embodiments network components can be connected via a fiber optical network. For example, a hub 115 and a node 120 can be connected by a fiber optical network 125. The fiber optical network 125 can pass forward and reverse data along one or more optical fibers.

In embodiments, the fiber optical network 125 may include a dual transmitter pluggable 130. The dual transmitter pluggable 130 can be operable to receive two electrical input signals (e.g., channels), convert the data streams to optical signals, and output each optical signal at a corresponding wavelength 131 along one or more optical fibers. In embodiments, the dual transmitter pluggable 130 may include two transmit optical sub-assemblies (TOSA).

One or more optical transmitters 132 may be contained in a housing, and the optical transmitters can comprise: a laser configured to be modulated to provide a quadrature amplitude modulation (QAM) modulated signal based on an input signal (e.g., radio frequency (RF) data signal 133); a thermo-electric driver configured to control a thermo-electric device to control an operating temperature of the laser; and pre-distortion circuits configured to correct distortions associated with the RF data signal.

The one or more optical transmitters 132 may further comprise a power control circuit configured to control power in the laser and a microprocessor configured to receive instructions from a host external to the optical transmitters 132 and configured to control the thermo-electric driver and the power control circuit. The one or more optical transmitters 132 may also further comprise an RF attenuator which is configured to attenuate the RF data signal, wherein the microprocessor is configured to control the RF attenuator. An RF amplifier which is configured to provide gain to the RF data signal may also be included in the optical transmitters 132.

In embodiments, the fiber optical network 125 may include a dual receiver pluggable 135. In embodiments, the dual receiver pluggable 135 may include one or more receivers 136, and each receiver 136 may comprise a receive optical sub-assembly (ROSA). The dual receiver pluggable 135 can be operable to receive optical signals at two different optical wavelengths, convert optical signals received at the optical wavelengths to electrical output signals 137, and output the electrical output signals 137 (e.g., output to node 120).

It should be understood that the data path can be reversed (e.g., reverse data traffic output upstream from the customer premise 105) and the position of the dual transmitter pluggable 130 can be swapped with the dual receiver pluggable 135 to support reverse data traffic.

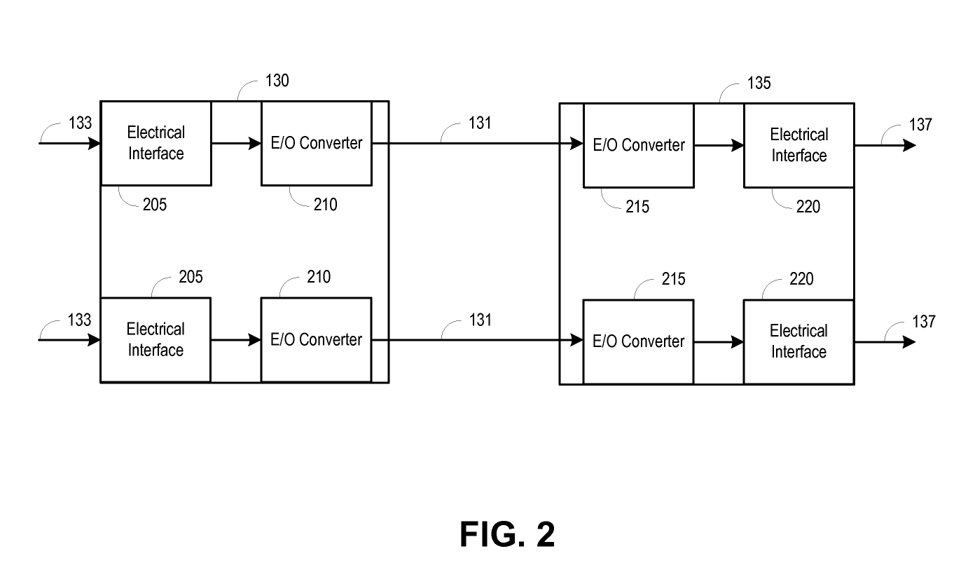

FIG. 2 is a block diagram illustrating example network components operable to facilitate the transmission of data traffic at one or more optical wavelengths. In embodiments, a dual transmitter pluggable 130 may include one or more electrical interfaces 205 and one or more electrical/optical (E/O) converters 210. An electrical input signal 133 can be received by the dual transmitter pluggable 130 via an electrical interface 205. For example, the dual transmitter pluggable 130 can receive an electrical input signal 133 at each of one or more electrical interfaces 205.

In embodiments, a received electrical input signal can be converted to an optical signal. For example, each electrical input signal received by the dual transmitter pluggable 130 can be converted to an optical signal by an E/O converter 210. In embodiments, each optical signal can be output to a dual receiver pluggable 135 at two different wavelengths 131 along one or more optical fibers. For example, each optical signal can be output along an optical fiber. In embodiments, each optical signal can be tunable. For example, a wavelength associated with each optical signal can be tunable.

In embodiments, a dual receiver pluggable 135 may include one or more E/O converters 215 and one or more electrical interfaces 220. The dual receiver pluggable 135 can receive one or more optical signals at different optical wavelengths, wherein each optical signal can be received by an E/O converter 215. In embodiments, each optical signal can be converted to an electrical output signal 137 by an E/O converter 215, and each electrical output signal 137 can be output through an electrical interface 220.

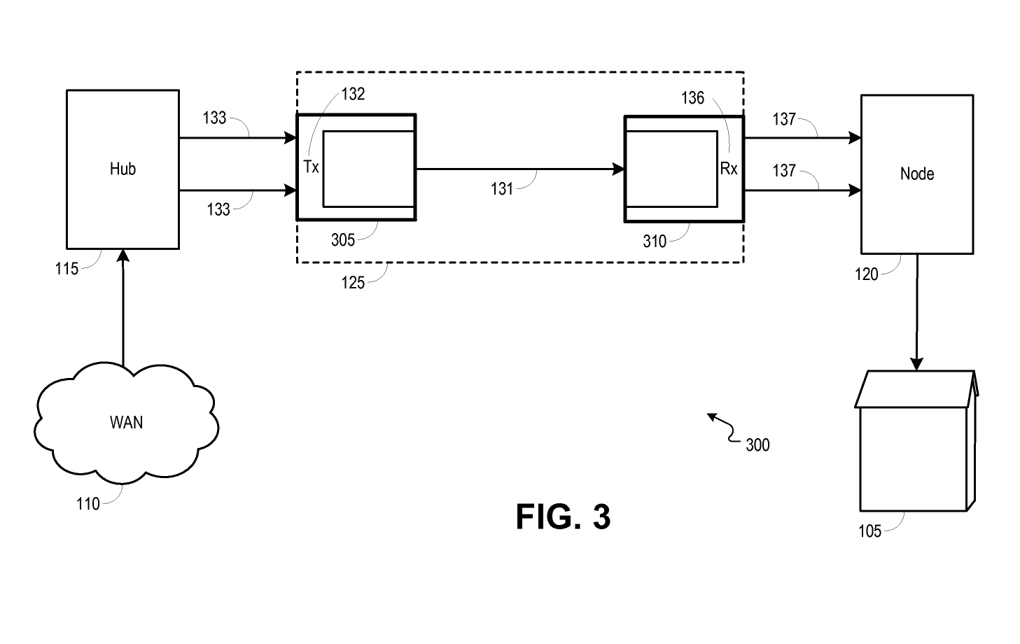

FIG. 3 is a block diagram illustrating an example network environment 300 operable to facilitate the transmission of data traffic along a single optical fiber. In embodiments, video, data, and/or voice services can be delivered to a subscriber premise 105 from a WAN 110. In embodiments, communications between the WAN 110 and the subscriber premise 105 can be routed through one or more of various network components including, but not limited to, a headend (not shown), hub 115, node 120, as well as others.

In embodiments network components can be connected via a fiber optical network. For example, a hub 115 and a node 120 can be connected by a fiber optical network 125. The fiber optical network 125 can pass forward and reverse data along one or more optical fibers.

In embodiments, the fiber optical network 125 may include a double capacity transmitter pluggable 305. In embodiments, the double capacity transmitter pluggable may include a single optical transmitter 132. The double capacity transmitter pluggable 305 can be operable to receive two or more electrical input signals, combine the electrical input signals into a combined electrical data stream, convert the combined electrical data stream to one or more optical signals, and output the optical signal(s) at a single wavelength 131.

In embodiments, the fiber optical network 125 may include a double capacity receiver pluggable 310. In embodiments, the double capacity receiver pluggable 310 may include a single optical receiver 136. The double capacity receiver pluggable 310 can be operable to receive optical signals from an optical fiber, separate received optical signals into individual signals, convert received optical signals to electrical output signals 137, and output the electrical output signals 137 (e.g., output to node 120).

It should be understood that the data path can be reversed (e.g., reverse data traffic output upstream from the customer premise 105) and the position of the double capacity transmitter pluggable 305 can be swapped with the double capacity receiver pluggable 310 to support reverse data traffic.

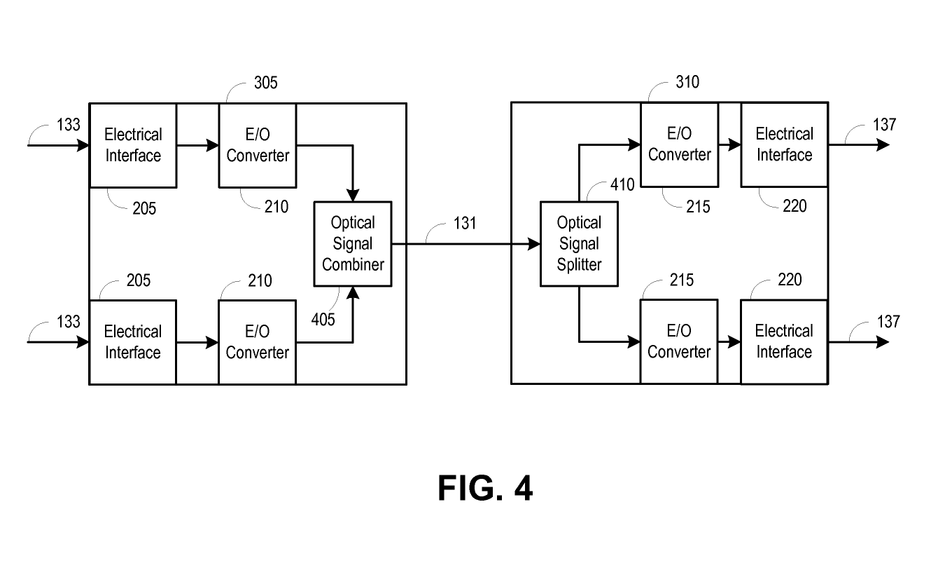

FIG. 4 is a block diagram illustrating example network components operable to facilitate the transmission of data traffic along a single optical fiber. In embodiments, a double capacity transmitter pluggable 305 can receive one or more input signals 133 through one or more electrical interfaces 205 and can convert received electrical input signals 133 to optical signals using one or more E/O converters 210.

In embodiments, optical signals generated by the one or more E/O converters 210 can be combined at an optical signal combiner 405. It should be understood that many different methods may be used to combine the optical signals (e.g., quadrature phase shift keying (QPSK), wavelength-division multiplexing (WDM) (including dense wavelength-division multiplexing (DWM) and coarse wavelength-division multiplexing (CWM), dual wavelength transmission on two closely spaced wavelengths, and others). For example, the optical signal combiner 405 may include a WDM component and can combine light sources having different wavelengths. In embodiments, optical signals can be combined using QPSK by applying one optical signal to the “in-phase” component and one optical signal to the QAM component of a QPSK signal. In embodiments, a combined optical signal can be output at a single wavelength 131 along an optical fiber to a double capacity receiver pluggable 310.

In embodiments, a double capacity receiver pluggable 310 may include an optical signal splitter 410, one or more E/O converters 215, and one or more electrical interfaces 220. The double capacity receiver pluggable 310 can receive a combined optical signal from an optical fiber, wherein the optical signal is received at a single wavelength, and the combined optical signal can be separated out into the signal's two or more component signals (e.g., portion(s) of the combined optical signal embodying a corresponding electrical data stream as received by the double capacity transmitter pluggable 305) by the optical signal splitter 410. Component signals can be separated out by applying any one of various demodulation techniques to the combined optical signal. For example, the optical signal splitter 410 may include a WDM component and can separate light sources of different wavelengths. In embodiments, each optical signal can be converted to an electrical output signal 137 by an E/O converter 215, and each electrical output signal 137 can be output through an electrical interface 220.

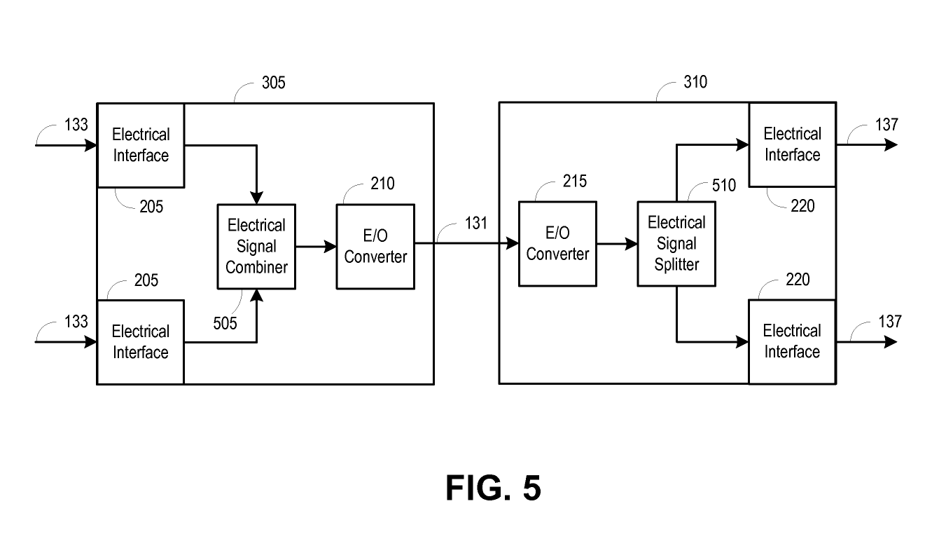

FIG. 5 is a block diagram illustrating example network components operable to facilitate the transmission of data traffic along a single optical fiber. In embodiments, a double capacity transmitter pluggable 305 may include one or more electrical interfaces 205, an electrical signal combiner 505, and an E/O converter 210. The double capacity transmitter pluggable 305 can receive one or more input signals 133 through the one or more electrical interfaces 205.

In embodiments, the received electrical input signals 133 can be combined at the electrical signal combiner 505. It should be understood that many different methods may be used to combine the electrical signals (e.g., amplitude shift keying (ASK), quadrature phase shift keying (QPSK), and others). In embodiments, a combined electrical signal can be converted to an optical signal by the E/O converter 210 and can be output at a single wavelength 131 along an optical fiber to a double capacity receiver pluggable 310.

In embodiments, a double capacity receiver pluggable 310 may include an E/O converter 215, an electrical signal splitter 510, and one or more electrical interfaces 220. The double capacity receiver pluggable 310 can receive a combined optical signal from an optical fiber, wherein the optical signal is received at a single wavelength, and the combined optical signal can be converted into an electrical signal by the E/O converter 215. In embodiments, the electrical signal can be separated out into two or more component signals by the electrical signal splitter 510. Component signals can be separated out by applying any one of various demodulation techniques to the combined electrical signal. In embodiments, each electrical output signal 137 can be output through an electrical interface 220.

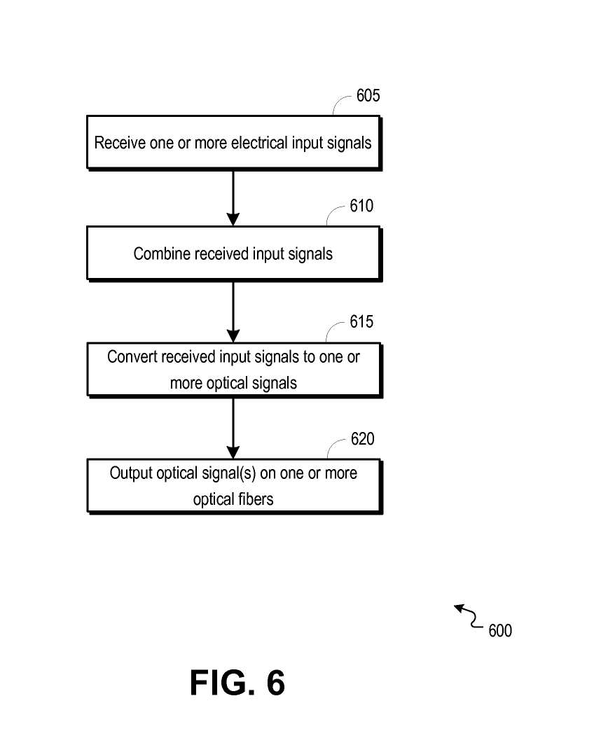

FIG. 6 is a flowchart illustrating an example process 600 operable to facilitate transmission of data traffic along an optical fiber. The process 600 can begin at 605 when one or more electrical input signals are received at a transmitter pluggable (e.g., dual transmitter pluggable 130 of FIG. 1 or double capacity transmitter pluggable 305 of FIG. 3).

At 610, signals associated with the one or more electrical input signals can be combined. The signals can be combined, for example, by a signal combiner (e.g., optical signal combiner 405 of FIG. 4 or electrical signal combiner 505 of FIG. 5). In embodiments, when the signals to be combined are electrical signals, the signals can be combined by the electrical signal combiner 505 of FIG. 5. In embodiments, when the signals to be combined are optical signals, the signals can be combined by the optical signal combiner 405 of FIG. 4.

At 615, signals associated with the one or more electrical input signals can be converted into one or more optical signals. An electrical signal can be converted into an optical signal, for example, by an E/O converter 210 of FIG. 2. It should be understood that 615 can occur prior to, or after 610. In embodiments, when electrical input signals are to be combined, the electrical input signals can be combined at 610, and the combined electrical signal can be converted to an optical signal at 615. In embodiments, when optical signals are to be combined, the electrical input signals can be converted to optical signals at 615, and the optical signals can then be combined at 610.

At 620, one or more combined optical signals can be output on one or more optical fibers. The optical signal(s) can be output, for example, to a receiver (e.g., dual receiver pluggable 135 of FIG. 1 or double capacity receiver pluggable 310 of FIG. 3).

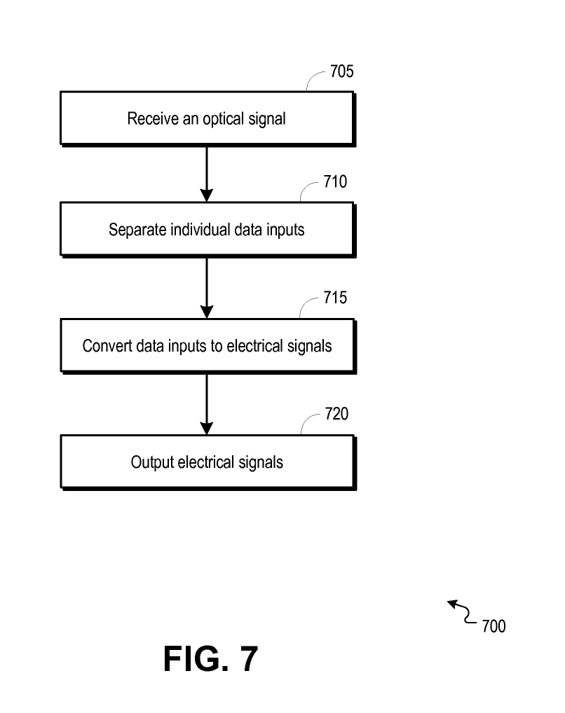

FIG. 7 is a flowchart illustrating an example process 700 operable to facilitate transmission of data traffic along an optical fiber. The process 700 can begin at 705 when an optical signal is received at a receiver pluggable (e.g., dual receiver pluggable 135 of FIG. 1 or double capacity receiver pluggable 310 of FIG. 3). In embodiments, the optical signal can comprise two or more component signals (e.g., signals associated with electrical input signals).

At 710, the received signal can be separated into two or more component signals. The received signal can be separated out into two or more component signals, for example, by a signal splitter (e.g., optical signal splitter 410 of FIG. 4 or electrical signal splitter 510 of FIG. 5). Component signals can be separated out by applying any one of various demodulation techniques to the combined signal. In embodiments, when the signal to be split is an electrical signal, the signal can be split by the electrical signal splitter 510 of FIG. 5. In embodiments, when the signal to be split is an optical signal, the signal can be split by the optical signal splitter 410 of FIG. 4.

At 715, the received optical signal or the two or more optical signals separated out from a received optical signal can be converted into an electrical signal. An optical signal can be converted into an electrical signal, for example, by an E/O converter 215 of FIG. 2. It should be understood that 715 can occur prior to, or after 710. In embodiments, when an optical signal is to be split, the received optical signal can be split at 710, and the resulting, separated optical signals can be converted to electrical signals at 715. In embodiments, when an electrical signal is to be split, the received optical signal can be converted to an electrical signal at 715, and the electrical signal can then be split at 710.

At 720, separated, individual electrical signals can be output to a destination. For example, when the data being transported is forward data, the electrical signals can be output downstream to a node 120 of FIG. 1, subscriber premise 105 of FIG. 1, or other downstream network component. When the data being transported is reverse data, the electrical signals can be output upstream to a hub 115 of FIG. 1, a WAN 110 of FIG. 1, or other upstream network component. In embodiments, the output electrical signals can be equivalent to the original signals received at an associated transmitter (e.g., dual transmitter pluggable 130 of FIG. 1 or double capacity transmitter pluggable 305 of FIG. 3) and can be constructed from the individual component signals.

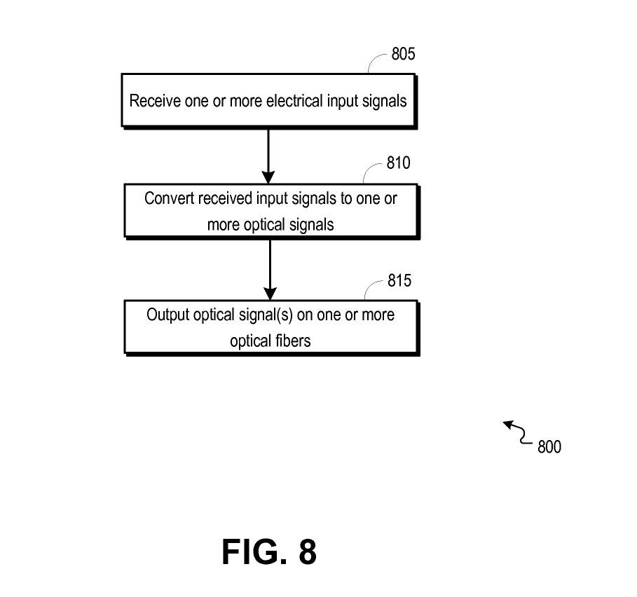

FIG. 8 is a flowchart illustrating an example process 800 operable to facilitate transmission of data traffic at two different wavelengths. The process 800 can begin at 805 when one or more electrical input signals are received at a transmitter pluggable (e.g., dual transmitter pluggable 130 of FIG. 1).

At 815, the one or more electrical input signals can be converted into one or more optical signals. An electrical signal can be converted into an optical signal, for example, by an E/O converter 210 of FIG. 2.

At 820, the one or more optical signals can be output on one or more optical fibers. The optical signal(s) can be output, for example, to a receiver (e.g., dual receiver pluggable 135 of FIG. 1). In embodiments, the one or more optical signals can be output along a single optical fiber at different wavelengths.

Those skilled in the art will appreciate that the invention improves upon methods, systems and apparatuses for delivering services over an optical fiber network. The methods, systems, and apparatuses described in this disclosure enable the use of pluggable optics such that two outgoing connections can support the use of dual transmitter optics. Supporting dual transmitter optics allows the capacity of forward data to be doubled by removing or reducing the reverse capacity of the pluggable optics. In embodiments, the forward capacity can be doubled using two transmitters operating in parallel, each putting out data at a wavelength on a fiber. In embodiments, forward capacity can be doubled using a double capacity transmitter that is operable to combine two or more input signals into a single optical signal.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving a first electrical signal and a second electrical signal;
converting the first electrical signal and the second electrical signal to one or more optical signals; and
outputting the one or more optical signals on one or more optical fibers.

2. The method of claim 1, wherein converting the first electrical signal produces a first optical signal and converting the second electrical signal produces a second optical signal, and the first optical signal and second optical signal are output on a single optical fiber at different wavelengths.

3. The method of claim 1, wherein converting the first electrical signal produces a first optical signal and converting the second electrical signal produces a second optical signal, further comprising:
before outputting the one or more optical signals on the one or more optical fibers, combining the first optical signal and the second optical signal.

4. The method of claim 3, wherein the first optical signal and the second optical signal are combined and output on a single optical fiber using wavelength-division multiplexing.

5. The method of claim 3, wherein the first optical signal and the second optical signal are combined and output on a single optical fiber using quadrature phase shift keying.

6. The method of claim 1, further comprising:
before converting the first electrical signal and the second electrical signal, combining the first electrical signal and the second electrical signal.

7. The method of claim 1, wherein the first electrical signal and the second electrical signal are received at an optical pluggable.

8. The method of claim 1, wherein the one or more optical signals are output to a downstream network component.

9. The method of claim 1, wherein the one or more optical signals are output to an upstream network component.

10. The method of claim 1, further comprising:
receiving, at a receiver, the one or more optical signals;
converting the one or more optical signals to one or more electrical signals;
separating data associated with the first electrical signal and data associated with the second electrical signal from the one or more electrical signals;
reconstructing the first electrical signal from the data associated with the first electrical signal;
reconstructing the second electrical signal from the data associated with the second electrical signal; and
outputting the first electrical signal and the second electrical signal.

11. An apparatus comprising:
a first electrical interface configured to receive a first electrical signal;
a second electrical interface configured to receive a second electrical signal;
a signal combiner configured to combine the first electrical signal and the second electrical signal, thus generating a combined electrical signal;
a converter configured to convert the combined electrical signal to an optical signal; and
an optical interface configured to output the optical signal onto an optical fiber.

12. The apparatus of claim 11, wherein the first electrical signal and the second electrical signal are combined using amplitude shift keying.

13. The apparatus of claim 11, wherein the first electrical signal and the second electrical signal are combined using quadrature phase shift keying.

14. The apparatus of claim 11, wherein the optical signal is output to an upstream network component.

15. The apparatus of claim 11, wherein the optical signal is output to a downstream network component.

16. An apparatus comprising:
a first electrical interface configured to receive a first electrical signal;
a second electrical interface configured to receive a second electrical signal;
a converter configured to convert the first electrical signal to a first optical signal and to convert the second electrical signal to a second optical signal;
a signal combiner configured to combine the first optical signal and the second optical signal, thus generating a combined optical signal; and
an optical interface configured to output the combined optical signal onto an optical fiber.

17. The apparatus of claim 16, wherein the first optical signal and the second optical signal are combined and output on a single optical fiber using wavelength-division multiplexing.

18. The apparatus of claim 16, wherein the first optical signal and the second optical signal are combined and output on a single optical fiber using quadrature phase shift keying.

19. The apparatus of claim 16, wherein the combined optical signal is output to a downstream network component.

20. The apparatus of claim 16, wherein the combined optical signal is output to an upstream network component.
